(19) United States
(12) Patent Application Publication
(10) Pub. No.: US 2011/0193886 A1
(43) Pub. Date: Aug. 11, 2011

(54) Organic light emitting display and method of driving the same

(76) Inventors: Min-Cheol Kim, Yongin-City (KR); Kyoung-Soo Lee, Yongin-City (KR)

(21) Appl. No.: 12/923,069

(22) Filed: Aug. 31, 2010

(30) Foreign Application Priority Data
Feb. 11, 2010 (KR) 10-2010-0012754

(51) Int. Cl. G09G 5/10; G09G 3/30

(52) U.S. Cl. 345/690; 345/76

(57) ABSTRACT

An organic light emitting display includes pixels positioned at intersections between data lines and scan lines, a data change unit receiving first data of i (i is a natural number) bits to generate second data of j (j is a natural number equal to or larger than i) bits so that a desired gamma value is realized, a gamma voltage unit for generating gray scale voltages corresponding to l (l is a natural number larger than i) bits, and a data driver for selecting one of the gray scale voltages as a data signal to correspond to the second data and for supplying the data signal to the data line.

### BACKGROUND

1. Field

Embodiments relate to an organic light emitting display and a method of driving the same, and more particularly, to an organic light emitting display capable of easily changing a gamma curve and of reducing manufacturing cost and a method of driving the same.

2. Description of the Related Art

Recently, various flat panel displays (FPD) capable of reducing weight and volume that are disadvantages of cathode ray tubes (CRT) have been developed. The FPDs include a liquid crystal display (LCD), a field emission display (FED), a plasma display panel (PDP), and an organic light emitting display.

Among the FPDs, the organic light emitting display displays an image using organic light emitting diodes (OLED) that generate light by re-combination of electrons and holes. The organic light emitting display has numerous advantages, including a high response speed and low power consumption.

The organic light emitting display includes pixels positioned at intersections between data lines and scan lines, a data driver for supplying data signals to the data lines, and a scan driver for supplying scan signals to the scan lines. The data driver selects one of the plurality of gray scale voltages output from a gamma voltage unit to correspond to the bits of data as a data signal. The scan driver sequentially supplies the scan signals to the scan lines. The pixels are selected when the scan signals are supplied to the scan lines, receive the data signals from the data lines, and supply currents corresponding to the received data signals to the OLEDs to display an image.

In the above-described conventional organic light emitting display, the gamma voltage unit includes a red gamma voltage unit, a green gamma voltage unit, and a blue gamma voltage unit. The red gamma voltage unit includes a red resist unit having a plurality of resistors and a red voltage supply unit for supplying a voltage to the red resist unit.

The red resist unit includes the plurality of serially connected resistors. The red voltage supply unit supplies a predetermined voltage to the partial node points of the plurality of resistors. The red voltage supply unit supplies a voltage so that gray scale voltages corresponding to gamma curves desired by the red resist unit may be generated. Each of the green gamma voltage unit and the blue gamma voltage unit includes a resist unit and a voltage supply unit and generates the gray scale voltages corresponding to the gamma curves.

However, the conventional organic light emitting display may not easily control the gamma curves. In the conventional art, in order to control the gamma curves, the designs of the resist unit and the voltage supply unit must be changed. In addition, in the conventional art, since three resist units and three voltage supply units are included, manufacturing cost increases.

### SUMMARY

Embodiments are therefore directed to an organic light emitting display and method of driving the same, which substantially overcome one or more of the problems due to the limitations and disadvantages of the related art.

It is therefore a feature of an embodiment to provide an organic light emitting display capable of easily changing gamma curves while reducing manufacturing cost and a method of driving the same.

At least one of the above and other features and advantages may be realized by providing, according to an embodiment, an organic light emitting display, including pixels positioned at intersections between data lines and scan lines, a data change unit receiving first data of i (i is a natural number) bits to generate second data of j (j is a natural number equal to or larger than i) bits so that a desired gamma value is realized, a gamma voltage unit for generating gray scale voltages corresponding to l (l is a natural number larger than i) bits, and a data driver for selecting one of the gray scale voltages as a data signal to correspond to the second data and for supplying the data signal to the data line.

The data change unit includes a bit expanding unit for expanding the first data of the i bits to the l bits to generate expanded data, a dithering unit for controlling the bits of the expanded data in order to express a linear gray scale, at least one lookup table for storing gamma data of the l bits corresponding to a desired gamma value, and a controller for extracting the gamma data corresponding to the expanded data output from the dithering unit and for outputting the extracted gamma data as the second data.

The data change unit further includes a bit reducing unit for changing the gamma data of the l bits supplied from the controller to data of the i bits and an error compensating unit for compensating errors of the data of the i bits and for outputting the error compensated data of the i bits as the second data. The gamma voltage unit includes a resist unit including a plurality of resistors so that the gray scale voltages corresponding to the l bits may be generated and a voltage supply unit for generating a plurality of reference voltages and for supplying the generated reference voltages to partial nodes among the resistors.

A method of driving an organic light emitting display using first data of i (i is a natural number) bits input from the outside includes generating gray scale voltages corresponding to l (l is a natural number larger than i) bits, generating second data of j (j is a natural number equal to or larger than i) bits so that a desired gamma value is realized using the first data, selecting one of the gray scale voltages to correspond to the second data, and supplying the data signal to a pixel to generate light of predetermined brightness.

Generating the second data includes adding lower bits to the first data to generate expanded data of the l bits, randomly changing the added lower bit value, extracting one of the gamma data of the plurality of l bits stored in a lookup table using the expanded data whose lower bit value is changed, and outputting the extracted gamma data as the second data.

Generating the second data further includes changing the extracted gamma data to the data of the i bits, compensating for errors of the i bit data, and outputting the error compensated i bit data as the second data.

In the organic light emitting display according to the present invention and the method of driving the same, since only one gamma voltage unit and only one resist unit are included, manufacturing cost may be reduced. In addition, according to the present invention, since gammas are realized using second data, a lookup table may be updated to be applied to various types of gammas.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 illustrates a block diagram of an organic light emitting display according to an embodiment;

FIG. 2 illustrates a block diagram of a first embodiment of the data change unit of FIG. 1;

FIGS. 3A and 3B illustrate views of the function of the dithering unit of the pixel of FIG. 2;

FIG. 4 illustrates a block diagram of an embodiment of the gamma voltage unit of FIG. 1 according to an embodiment; and

FIG. 5 illustrates a block diagram of a second embodiment of the data change unit of FIG. 1.

### DETAILED DESCRIPTION

Korean Patent Application No. 10-2010-0012754, filed on Feb. 11, 2010, in the Korean Intellectual Property Office, and entitled: “Organic Light Emitting Display and Method of Driving the Same,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

Here, when a first element is described as being coupled to a second element, the first element may be not only directly coupled to the second element but may also be indirectly coupled to the second element via a third element. Further, some of the elements that are not essential to the complete understanding of the invention are omitted for clarity. Also, like reference numerals refer to like elements throughout.

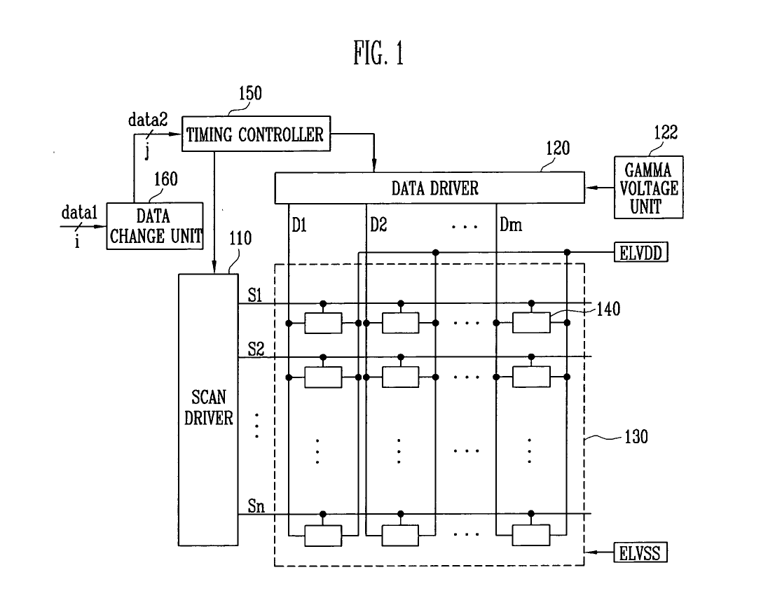

FIG. 1 illustrates a block diagram of an organic light emitting display according to an embodiment. In FIG. 1, for convenience sake, a data change unit 160 is illustrated as being external to a timing controller 150. However, embodiments are not limited to the above. For example, the data change unit 160 may be incorporated inside the timing controller 150.

Referring to FIG. 1, the organic light emitting display according to the present embodiment includes a pixel unit 130 including pixels 140 positioned at intersections of scan lines S1 to Sn and data lines D1 to Dm, a scan driver 110 for driving the scan lines S1 to Sn, a data driver 120 for driving the data lines D1 to Dm, the timing controller 150 for controlling the scan driver 110 and the data driver 120, the data change unit 160 for generating second data data2 using first data data1 supplied from the outside, and a gamma voltage unit 122 for generating gray scale voltages.

The scan driver 110 generates scan signals by the control of the timing controller 150 and sequentially supplies the generated scan signals to the scan lines S1 to Sn.

The data driver 120 receives the second data data2 from the timing controller 150. The data driver 120 that has received the second data data2 in each channel selects one of the gray scale voltages generated by the gamma voltage unit 122 to correspond to the second data data2 and supplies the selected voltage to a data line (one of D1 to Dm) as the data signal of the corresponding channel.

The data change unit 160 receives the first data data1 of i (i is a natural number) bits from the outside. The data change unit 160 that received the first data data1 of i bits generates the second data data2 of j (j is a natural number equal to or larger than i) bits using the first data data1 of i bits. The second data data2 are generated to correspond to previously set gammas (for example, 2.2 gammas).

The gamma voltage unit 122 generates a plurality of gray scale voltages. The gamma voltage unit 122 generates the plurality of gray scale voltages to correspond to l (l is a natural number larger than i) bits. For example, when the bits of the first data data1 are set as 8 bits (i.e., i=8), the gamma voltage unit 122 may generate gray scale voltages corresponding to 10 bits (i.e., l=10).

The timing controller 150 controls the scan driver 110 and the data driver 120. In addition, the timing controller 150 realigns the second data data2 and transmits the second data data2 to the data driver 120.

The pixel unit 130 receives a first power source ELVDD and a second power source ELVSS, and supplies the first power source ELVDD and the second power source ELVSS to the pixels 140. The pixels 140 that have received the first power source ELVDD and the second power source ELVSS generate light in accordance with the data signals.

Briefly, each of the pixels 140 includes an organic light emitting diode (OLED), at least one capacitor, and at least one transistor. When the scan signals are supplied, the pixels 140 are sequentially selected in units of horizontal lines to receive the data signals. The data signals supplied to the pixels 140 are stored in the capacitors. Then, a driving transistor included in each of the pixels 140 controls the amount of current that flows from the first power source ELVDD to the second power source ELVSS via the OLED to correspond to the data signal stored in the capacitor. At this time, the OLED generates light of predetermined brightness to correspond to the amount of current.

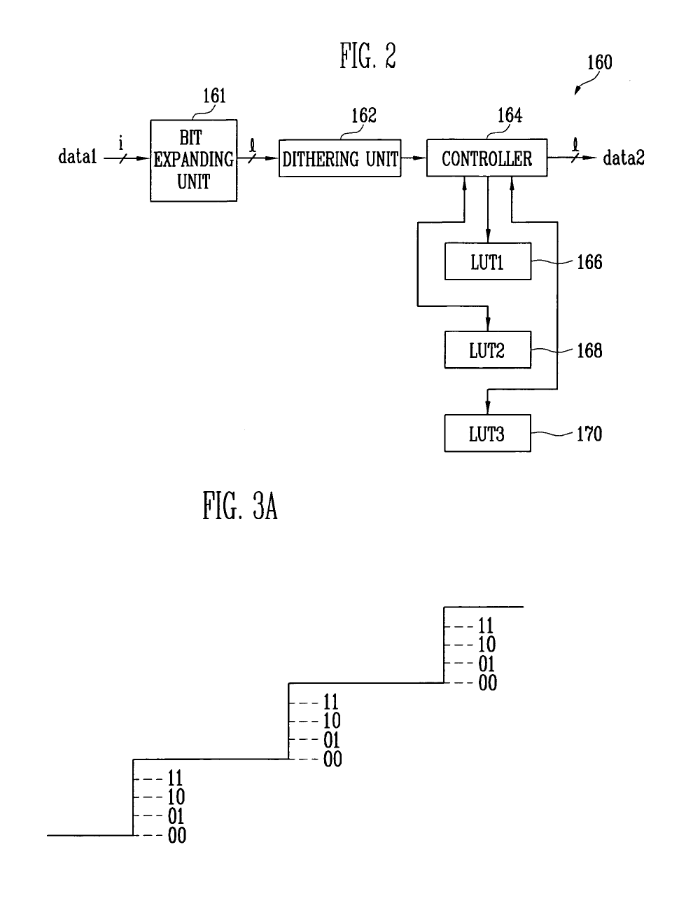

FIG. 2 illustrates a block diagram of a first embodiment of the data change unit of FIG. 1. Referring to FIG. 2, the data change unit 160 according to the present embodiment includes a bit expanding unit 161, a dithering unit 162, a controller 164, and lookup tables 166, 168, and 170.

The bit expanding unit 161 generates expanded data of l bits using the first data data1 of i bits. For example, the bit expanding unit 161 expands the first data data1 of i bits by 2 to generate the expanded data of l bits. In this case, the bit expanding unit 161 adds lower bits of “00” to the first data data1 of i bits to generate the expanded data of l bits.

In detail, when the first data data1 of “00000001” are input, the bit expanding unit 161 adds lower bits of “00” to generate expanded data of “0000000100”. When the first data data1 of “11111111” are input, the bit expanding unit 161 generates the expanded data of “1111111100”.

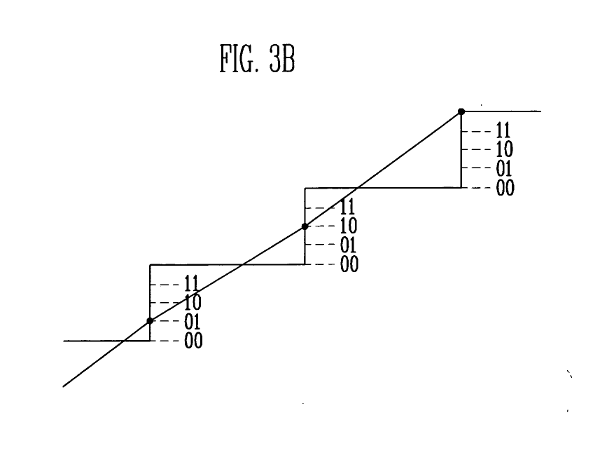

The dithering unit 162 randomly changes the value of the lower 2 bits of the expanded data so that a linear gray scale may be expressed. In detail, when the lower 2 bits of the expanded data are fixed to “00”, as illustrated in FIG. 3A, the value of the expanded data increases in a stepwise manner. Therefore, when gamma data are selected using the expanded data, a gray scale may nonlinearly increase. Therefore, the dithering unit 162 according to the present embodiment randomly changes the value of the lower 2 bits of the expanded data to one of “00”, “01”, “10”, and “11”. Then, as illustrated in FIG. 3B, the value of the expanded data linearly increases.

Red gamma data of l bits corresponding to red pixels are stored in a first lookup table LUT1 166. For example, the red gamma data corresponding to the 2.2 gammas may be stored in the first lookup table 166. According to the present embodiment, the red gamma data stored in the first lookup table 166 are updated to easily control the gamma value.

Green gamma data of l bits corresponding to green pixels are stored in the second lookup table 168. For example, the green gamma data corresponding to the 2.2 gammas may be stored in the second lookup table 168. According to the present embodiment, the green gamma data stored in the second lookup table 168 are updated to easily control the gamma value.

Blue gamma data of l bits corresponding to blue pixels are stored in the third lookup table 170. For example, blue gamma data corresponding to the 2.2 gammas may be stored in the third lookup table 170. According to the present embodiment, the blue gamma data stored in the third lookup table 170 are updated to easily control the gamma value.

The controller 164 extracts the gamma data from one of the first lookup table 166 to the third lookup table 170 to correspond to the expanded data supplied from the dithering unit 162. For example, when the expanded data to be supplied to the red pixels are supplied, the controller 164 extracts the red gamma data corresponding to the expanded data from the first lookup table 166 and supplies the extracted red gamma data to the timing controller 150 as the second data data2.

In addition, when the expanded data to be supplied to the green pixels are supplied, the controller 164 extracts the green gamma data corresponding to the expanded data from the second lookup table 168 and supplies the extracted green gamma data to the timing controller 150 as the second data data2. In addition, when the expanded data to be supplied to the blue pixels are supplied, the controller 164 extracts the blue gamma data corresponding to the expanded data from the third lookup table 170 and supplies the extracted blue gamma data to the timing controller 150 as the second data data2.

Then, the timing controller 150 supplies the second data data2 supplied from the data changing unit 160 to the data driver 120. The data driver 120 selects a gray scale voltage from the gamma voltage unit 122 to correspond to the second data data2 and supplies the selected gray scale voltage to the pixel 140 as a data signal.

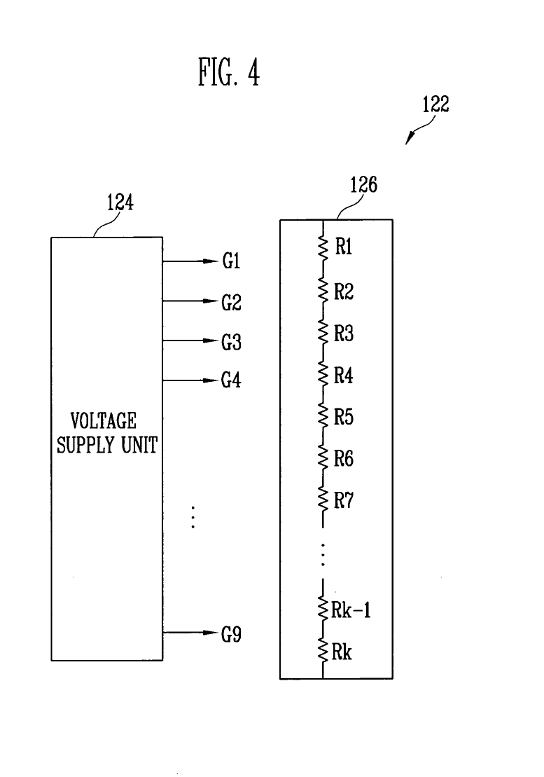

FIG. 4 illustrates a block diagram of illustrating the gamma voltage unit of FIG. 1 in accordance with an embodiment. Referring to FIG. 4, the gamma voltage unit 122 includes a voltage supply unit 124 and a resist unit 126.

The resist unit 126 includes a plurality of serially arranged resistors R1 to Rk. Voltages generated by nodes among the resistors R1 to Rk are supplied to the data driver 120 as gray scale voltages. Therefore, the number of resistors R1 to Rk is set so that the gray scale voltages corresponding to l bits may be generated.

The voltage supply unit 124 generates a plurality of reference voltages G1 to G9 and supplies the generated reference voltages G1 to G9 to partial nodes among the resistors R1 to Rk. That is, the voltage supply unit 124 generates the reference voltages G1 to G9 so that the gray scale voltages desired by the resist unit 126 may be generated and supplies the generated reference voltages G1 to G9 to the partial nodes among the resistors R1 to Rk.

On the other hand, according to the present embodiment, the gamma voltage unit 122 generates the gray scale voltage corresponding to the l bits larger than the i bits. That is, according to the present invention, gammas are realized using the second data data2 generated using the first data data1 of i bits. Therefore, desired gammas may be realized by the second data data2 by generating the gray scale voltages corresponding to 2l larger than the gray scale voltages corresponding to 2i. That is, according to embodiments, the gray scale voltages corresponding to the l bits larger than the i bits are generated and one gray scale voltage corresponding to the second data data2 is selected among the plurality of gray scale voltages to realize desired gammas.

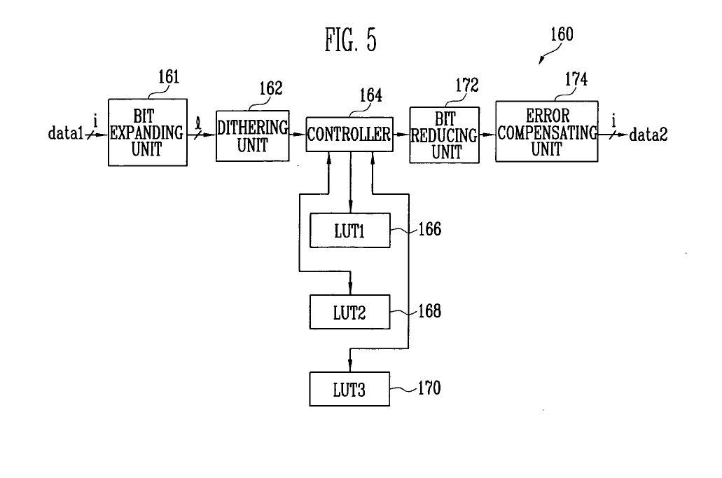

FIG. 5 illustrates a block diagram of a second embodiment of the data change unit of FIG. 1. When FIG. 5 is described, the same elements as those of FIG. 2 are denoted by the same reference numerals and detailed description thereof will be omitted.

Referring to FIG. 5, the data change unit 160 according to the second embodiment of the present invention further includes a bit reducing unit 172 and an error compensating unit 174.

The bit reducing unit 172 changes the gamma data of l bits supplied from the controller 164 to the data of i bits. For example, the bit reducing unit 172 removes the lower 2 bits of the gamma data of the t bits to generate the data of i bits.

As illustrated in FIG. 2, when the gamma data of l bits are supplied to the timing controller 150 as the second data data2, since transmission lines must be provided to correspond to the l bits, a partial circuit may be complicated. Therefore, according to the second embodiment, since the l bits are reduced to i bits using the bit reducing unit 172, increase in the manufacturing cost may be prevented.

The error compensating unit 174 compensates for the error of the data reduced from the l bits to the i bits. For example, the error compensating unit 174 randomly adds or subtracts a predetermined number (for example, a number no more than 5) to compensate for the error of the data. Actually, the error compensating unit 174 may apply currently known various types of algorithms in order to compensate for the error of the data. For example, the error compensating unit 174 may compensate for the error of the data using a frame rate control (FRC) algorithm. The data of i bits output from the error compensating unit 174 are supplied to the timing controller 150 as the second data data2.

Then, the timing controller 150 supplies the second data data2 supplied from the data change unit 160 to the data driver 120. The data driver 120 selects a gray scale voltage from the gamma voltage unit 122 to correspond to the second data data2 and supplies the selected gray scale voltage to the pixel 140 as a data signal.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. An organic light emitting display, comprising:
pixels positioned at intersections between data lines and scan lines;
a data change unit receiving first data of i (i is a natural number) bits to generate second data of j (j is a natural number equal to or larger than i) bits so that a desired gamma value is realized;
a gamma voltage unit for generating gray scale voltages corresponding to l (l is a natural number larger than i) bits; and
a data driver for selecting one of the gray scale voltages as a data signal to correspond to the second data and for supplying the data signal to the data line.

2. The organic light emitting display as claimed in claim 1, wherein the data change unit comprises:
a bit expanding unit for expanding the first data of the i bits to the l bits to generate expanded data;
a dithering unit for controlling the bits of the expanded data in order to express a linear gray scale;
at least one lookup table for storing gamma data of the l bits corresponding to a desired gamma value; and
a controller for extracting the gamma data corresponding to the expanded data output from the dithering unit and for outputting the extracted gamma data as the second data.

3. The organic light emitting display as claimed in claim 2, wherein the bit expanding unit adds “00” to lower 2 bits of the first data to generate the expanded data.

4. The organic light emitting display as claimed in claim 3, wherein the dithering unit randomly changes “00” added to the lower 2 bits to one of “00”, “01”, “10”, and “11”.

5. The organic light emitting display as claimed in claim 2, wherein the lookup table comprises:
a first lookup table for storing red gamma data to be supplied to red pixels;
a second lookup table for storing green gamma data to be supplied to green pixels; and
a third lookup table for storing blue gamma data to be supplied to blue pixels.

6. The organic light emitting display as claimed in claim 2, wherein the data change unit further comprises:
a bit reducing unit for changing the gamma data of the l bits supplied from the controller to data of the i bits; and
an error compensating unit for compensating errors of the data of the i bits and for outputting the error compensated data of the i bits as the second data.

7. The organic light emitting display as claimed in claim 6, wherein the bit reducing unit removes the lower 2 bits of the gamma data and generates the data of the i bits.

8. The organic light emitting display as claimed in claim 6, wherein the error compensating unit adds a predetermined number to or subtracts a predetermined number from the data of the i bits.

9. The organic light emitting display as claimed in claim 1, wherein the gamma voltage unit comprises:
a resist unit including a plurality of resistors so that the gray scale voltages corresponding to the l bits may be generated; and
a voltage supply unit for generating a plurality of reference voltages and for supplying the generated reference voltages to partial nodes among the resistors.

10. A method of driving an organic light emitting display using first data of i (i is a natural number) bits input from the outside, comprising:
generating gray scale voltages corresponding to l (l is a natural number larger than i) bits;
generating second data of j (j is a natural number equal to or larger than i) bits so that a desired gamma value is realized using the first data;
selecting one of the gray scale voltages to correspond to the second data; and
supplying the data signal to a pixel to generate light of predetermined brightness.

11. The method as claimed in claim 10, wherein generating the second data comprises:
adding lower bits to the first data to generate expanded data of the l bits;
randomly changing the added lower bit value;
extracting one of the gamma data of the plurality of l bits stored in a lookup table using the expanded data whose lower bit value is changed; and
outputting the extracted gamma data as the second data.

12. The method as claimed in claim 11, wherein “00” is added to the lower 2 bits of the first data so that the expanded data are generated.

13. The method as claimed in claim 12, wherein, in randomly changing the lower bit value, “00” added to the lower 2 bits is changed to one of “00”, “01”, “10”, and “11”.

14. The method as claimed in claim 11, wherein generating the second data further comprises:
changing the extracted gamma data to the data of the i bits;
compensating for errors of the i bit data; and
outputting the error compensated i bit data as the second data.

15. The method as claimed in claim 14, wherein, in changing the gamma data to the data of the i bits, the lower 2 bits of the gamma data are removed.

16. The method as claimed in claim 14, wherein, compensating for the errors includes adding a predetermined number to or subtracting a predetermined number from the data of the i bits.
